(19) United States
(12) Patent Application Publication
(10) Pub. No.: US 2004/0167277 A1
(43) Pub. Date: Aug. 26, 2004

(54) Thermoplastic molding compositions having good properties

(76) Inventors: Moh-Ching Oliver Chang, Wexford, PA (US); Karma Lee Hodge, Pittsburgh, PA (US)

Correspondence Address: BAYER POLYMERS LLC, 100 BAYER ROAD, PITTSBURGH, PA, 15205, US

(21) Appl. No.: 10/374,498

(22) Filed: Feb. 26, 2003

(51) Int. Cl. C08L 51/00

(52) U.S. Cl. 525/67

(57) ABSTRACT

A thermoplastic molding composition good processing characteristics, suitable for making articles having good mechanical properties is disclosed. The composition contains a resinous blend of (i) 2 to 60% of a grafted acrylate rubber, (ii) 10 to 97% of thermoplastic polyester and (iii) 1 to 30% of thermoplastic polyurethane, the percents being relative to the weight of the blend.

### FIELD OF THE INVENTION

The invention relates to thermoplastic molding compositions and in particular to compositions having good processability that are suitable for molding articles having good mechanical properties.

### SUMMARY OF THE INVENTION

A thermoplastic molding composition with good processing characteristics, suitable for making articles having good mechanical properties is disclosed. The composition contains a resinous blend of (i) 2 to 60% of a grafted acrylate rubber; (ii) 10 to 97% of thermoplastic polyester and (iii) 1 to 30% of thermoplastic polyurethane, the percents being relative to the weight of the blend.

### DETAILED DESCRIPTION OF THE INVENTION

The thermoplastic molding composition of the present invention contains a resinous blend comprising

(i) 2 to 60, preferably 5 to 45 percent grafted acrylate rubber (herein referred to as “ASA”);

(ii) 10 to 97, preferably 20 to 93 percent thermoplastic polyester and

(iii) 1 to 30, preferably 2 to 20 percent thermoplastic polyurethane (TPU), the percents being relative to the weight of the blend.

The thermoplastic polyester component of the inventive blend contains polybutylene terephthalate (PBT) and may optionally contain a blend of PBT with polyethyleneterephthalate (PET). In these embodiments of the invention, the amount of PET is 0 to 90 percent, preferably 0 to 75 percent, relative to the weight of the thermoplastic polyester component.

The ASA resin (acrylate-styrene-acrylonitrile interpolymer) entailed in the present invention is a known, substantially thermoplastic resin which comprises SAN matrix in which is dispersed a grafted acrylate elastomer phase. Advantageous ASA resins which are commercially available comprise a crosslinked (meth)acrylate elastomer, a crosslinked SAN copolymer and a substantially linear SAN copolymer. Substituted styrene, such as α-methyl styrene or vinyl toluene may be used in place of all or part of the styrene. Suitable crosslinking agents include polyfunctional ethylenically unsaturated monomer, such as diallyl fumarate and diallyl maleate.

The ASA resins may be prepared by a variety of known methods entailing emulsion or bulk polymerization. The preferred ASA resins are of core-shell structure; these structures are well known in the art and have been disclosed in, among others U.S. Pat. No. 3,944,631, that is incorporated herein by reference. The (meth)acrylate elastomer core portion of these resins may be composed of alkyl, aryl, or arylalkyl esters of acrylic or methacrylic acids. These may be prepared by a two-step process in which the (meth)acrylate elastomer core (which may be at least partially crosslinked, such as by the known incorporation of polyfunctional vinyl compounds) is covered with a thermoplastic shell of polymethyl methacrylate, polystyrene, styrene-acrylonitrile copolymer, or similar vinyl (co)polymers.

Other ASA resins which may be advantageously used in the composition of the invention are the types disclosed in U.S. Pat. Nos. 3,655,824; 3,830,878; 3,991,009; 4,433,102; 4,442,263; and 4,409,363, all of which are incorporated herein by reference. These ASA resins are thermoplastic resins that are typically made of an acrylate ester, styrene (or (α-methylstyrene), and acrylonitrile. These resins exhibit good impact, heat distortion and weathering characteristics.

The ASA component of the inventive composition is present in an amount of 2 to 60, preferably 5 to 45 percent relative to the weight of the resinous blend.

The polybutylene terephthalate useful in the context of the present invention is made of a dicarboxylic acid unit primarily comprising terephthalic acid unit and a diol unit primarily comprising 1,4-butane diol unit. Representative examples of the polybutylene terephthalate resin include polybutylene terephthalate consisting of the terephthalic acid unit and 1,4-butane diol unit, with no specific limitation, and include any polybutylene terephthalate unit comprising other dicarboxylic acid units and/or other diol units, at 20 mole % or less to all the structural units, if necessary. Other dicarboxylic acid units possibly contained in the polybutylene terephthalate resin include for example aromatic dicarboxylic acids such as isophthalic acid, phthalic acid, 2,6-naphthalane dicarboxylic acid, 1,5-naphthalene dicarboxylic acid, bis(p-carboxyphenyl)methane, anthracene dicarboxylic acid, 4,4′-diphenyl ether dicarboxylic acid, and sodium 5-sulfoisophthalate; aliphatic dicarboxylic acids such as adipic acid, sebacic acid, azelaic acid and dodecane dionic acid; alicyclic dicarboxylic acids such as 1,3-cyclohexane dicarboxylic acid and 1,4-cyclohexane dicarboxylic acid; and dicarboxylic acid units derived from ester-forming derivatives thereof (lower alkyl esters such as methyl ester and ethyl ester). The polybutylene terephthalate resin may satisfactorily contain one of the dicarboxylic acid units or two or more thereof.

Additionally, other diol units possibly contained in the polybutylene terephthalate resin include for example aliphatic diols with 2 to 10 carbon atoms, such as ethylene glycol, propylene glycol, neopentyl glycol, 2-methylpropane diol, 1,5-pentane diol, cyclohexane dimethanol and cyclohexane diol; and diol units derived from polyalkylene glycols with a molecular weight of 6000 or less, such as diethylene glycol, polyethylene glycol, poly-1,3-propylene glycol, and polytetramethylene glycol. The polybutylene terephthalate resin may satisfactorily contain one of the aforementioned diol units or two or more thereof.

Furthermore, the polybutylene terephthalate resin may satisfactorily contain one or two or more of the structural units derived from trifunctional monomers for example glycerin, trimethylol propane, pentaerythritol, trimellitic acid and pyromellitic acid, at 1 mol % or less to all the structural units. The polybutylene terephthalate has an intrinsic viscosity within a range of 0.5 to 2.0 dl/g when the viscosity is measured in a solution of the resin in a mixture solvent of phenol/tetrachloroethane (weight ratio of 60/40).

The optional polyethylene terephthalate comprise a dicarboxylic acid unit primarily comprising terephthalic acid unit and a diol unit primarily comprising ethylene glycol unit. The polyethylene terephthalate resin representatively includes for example polyethylene terephthalate consisting of terephthalic acid unit and ethylene glycol unit, and further includes a polyethylene terephthalate resin comprising other dicarboxylic acid units and/or diol units, at 20 mol % or less to all the structural units. Examples of other dicarboxylic acid units possibly contained in the polyethylene terephthalate resin include the aforementioned other dicarboxylic acid units as described concerning the polybutylene terephthalate resin (A), while the polyethylene terephthalate resin (B) may possibly contain one or two or more of the other dicarboxylic acid units.

Examples of the other diol units possibly contained in the polyethylene terephthalate resin include 1,4-butane diol and the other diol units as described concerning about the polybutylene terephthalate resin, and the polyethylene terephthalate resin may satisfactorily contain one or two or more of the other diol units described above.

Furthermore, the polyethylene terephthalate resin may satisfactorily contain one or two or more of the structural units derived from trifunctional monomers, as described above concerning the polybutylene terephthalate resin. The polyethylene terephthalate resin has an intrinsic viscosity within a range of 0.5 to 1.5 dl/g when the viscosity is measured in a solution of the resin in a mixture solvent of phenol/tetrachloroethane (weight ratio of 60/40).

The polyurethane component has no limitation in respect of its formulation other than the requirement that it be thermoplastic in nature, which means that it is prepared from substantially difunctional ingredients, i.e., organic diisocyanates and components being substantially difunctional in active hydrogen containing groups.

However, often times minor proportions of ingredients with functionalities higher than 2 may be employed. This is particularly true when using extenders such as glycerol, trimethylol propane, and the like. Such thermoplastic polyurethane compositions are generally referred to as TPU materials. Accordingly, any of the TPU materials known in the art may be employed within the scope of the present invention. For representative teaching on the preparation of TPU materials see Polyurethanes: Chemistry and Technology, Part II, Saunders and Frisch, 1964, pp 767 to 769, Interscience Publishers, New York, N.Y. and Polyurethane Handbook, Edited by G. Oertel 1985, pp 405 to 417, Hanser Publications, distributed in U.S.A. by Macmillan Publishing Co., Inc., New York, N.Y. Also see U.S. Pat. Nos. 2,929,800; 2,948,691; 3,493,634; 3,620,905; 3,642,964; 3,963,679; 4,131,604; 4,169,196; Re 31,671; 4,245,081; 4,371,684; 4,379,904; 4,447,590; 4,523,005; 4,621,113; 4,631,329; and 4,883,837, the disclosure of which is incorporated herein by reference.

The preferred TPU is a polymer prepared from a mixture comprising at least one organic diisocyanate, at least one polymeric diol and at least one difunctional extender. The TPU may be prepared by the prepolymer, quasi-prepolymer, or one-shot methods in accordance with the methods described in the references cited above.

Any of the organic diisocyanates previously employed in TPU preparation may be employed including blocked or unblocked aromatic, aliphatic, and cycloaliphatic diisocyanates, and mixtures thereof.

Illustrative isocyanates but non-limiting thereof are methylene bis(phenyl isocyanate) including the 4,4′-isomer, the 2,4′-isomer and mixtures thereof, m- and p-phenylene diisocyanates, chlorophenylene diisocyanates, α,α′-xylylene diisocyanate,2,4- and 2,6-toluene diisocyanate and the mixtures of these latter two isomers which are available commercially, tolidine diisocyanate, hexamethylene diisocyanate, 1,5-naphthalene diisocyanate, isophorone diisocyanate and the like; cycloaliphatic diisocyanates such as methylene bis(cyclohexyl isocyanate) including the 4,4′-isomer, the 2,4′-isomer and mixtures thereof, and all the geometric isomers thereof including trans/trans, cis/trans, cis/cis and mixtures thereof, cyclohexylene diisocyanates (1,2-;1,3-; or 1,4-), 1-methyl-2,5-cyclohexylene diisocyanate, 1-methyl-2,4-cyclohexylene diisocyanate,1-methyl-2,6-cyclohexylene diisocyanate, 4,4′-isopropylidene bis-(cyclohexyl isocyanate), 4,4′-diisocyanato dicyclohexyl, and all geometric isomers and mixtures thereof, and the like. Also included are the modified forms of methylene bis(phenyl isocyanate). By the latter are meant those forms of methylene bis(phenyl isocyanate) which have been treated to render them stable liquids at ambient temperature (about 20 degree C.). Such products include those which have been reacted with a minor amount (up to about 0.2 equivalents per equivalent of polyisocyanate) of an aliphatic glycol or a mixture of aliphatic glycols such as the modified methylene bis(phenyl isocyanates) described in U.S. Pat. Nos. 3,394,164; 3,644,457; 3,883,571; 4,031,026; 4,115,429; 4,118,411; and 4,299,347 the disclosure of which is incorporated herein by reference. The modified methylene bis(phenyl isocyanates) also include those which have been treated so as to convert a minor proportion of the diisocyanate to the corresponding carbodiimide which then interacts with further diisocyanate to form urethane-imine groups, the resulting product being a stable liquid at ambient temperatures as described, for example, in U.S. Pat. No. 3,384,653. Mixtures of any of the above-named polyisocyanates can be employed if desired.

Preferred classes of organic diisocyanates include the aromatic and cycloaliphatic diisocyanates. Preferred species within these classes are methylene bis(phenyl isocyanate) including the 4,4′-isomer, the 2,4′-isomer, and mixtures thereof, and methylene bis(cyclohexyl isocyanate) inclusive of the isomers described above.

The polymeric diols which may be used are those conventionally employed in the art for the preparation of TPU elastomers. The polymeric diols are responsible for the formation of soft segments in the resulting polymer and advantageously have molecular weights (number average) falling in the range of 400 to 4000 and preferably 500 to 3000. It is not unusual, and, in some cases, it is advantageous to employ more than one polymeric diol. Exemplary of the diols are polyether diols, polyester diols, hydroxy-terminated polycarbonates, hydroxy-terminated polybutadienes, hydroxy-terminated polybutadiene-acrylonitrile copolymers, hydroxy-terminated copolymers of dialkyl siloxane and alkylene oxides such as ethylene oxide, propylene oxide and the like, and mixtures in which any of the above polyols are employed as major component (greater than 50% w/w) with amino-terminated polyethers and amino-terminated polybutadiene-acrylonitrile copolymers.

Illustrative of polyether polyols are polyoxyethylene glycols, polyoxypropylene glycols which, optionally, have been capped with ethylene oxide residues, random and block copolymers of ethylene oxide and propylene oxide; polytetramethylene glycol, random and block copolymers of tetrahydrofuran and ethylene oxide and/or propylene oxide, and products derived from any of the above reaction with di-functional carboxylic acids or ester derived from said acids in which latter case ester interchange occurs and the esterifying radicals are replaced by polyether glycol radicals. The preferred polyether polyols are random and block copolymers of ethylene and propylene oxide of functionality approximately 2.0 and poly- tetramethylene glycol polymers of functionality about 2.0.

Illustrative of polyester polyols are those prepared by polymerizing .epsilon.-caprolactone using an initiator such as ethylene glycol, ethanolamine, and the like; and those prepared by esterification of polycarboxylic acids such as phthalic, terephthalic, succinic, glutaric, adipic, azelaic, and the like; acids with polyhydric alcohols such as ethylene glycol, butanediol, cyclohexane dimethanol, and the like.

Illustrative of the amine-terminated polyethers are the aliphatic primary di-amines structurally derived from polyoxypropylene glycols. Polyether diamines of this type are available from Jefferson Chemical Company under the trademark JEFFAMINE.

Illustrative of polycarbonates containing hydroxyl groups are those prepared by reaction of diols such as propane-1,3-diol, butane-1,4-diol, hexane-1,6-diol, 1,9-nonanediol, 2-methyloctane-1,8-diol, diethylene glycol, triethylene glycol, dipropylene glycol, and the like, with diarylcarbonates such as diphenylcarbonate or with phosgene.

Illustrative of the silicon-containing polyethers are the copolymers of alkylene oxides with dialkylsiloxanes such as dimethylsiloxane, and the like; see, for example, U.S. Pat. Nos. 4,057,595 or 4,631,329 cited above.

The difunctional extender employed can be any of those known in the TPU art disclosed above. Typically the extenders may be aliphatic straight and branched chain diols having from 2 to 10 carbon atoms, inclusive, in the chain. Illustrative of such diols are ethylene glycol, 1,3-propanediol, 1,4-butanediol, 1,5-pentanediol, 1,6-hexanediol, neopentyl glycol, and the like; 1,4-cyclohexandimethanol; hydroquinone bis-(hydroxy-ethyl)ether, cyclohexylenediols (1,4-, 1,3-, and 1,2-isomers), isopropylidene bis(cyclohexanols); diethylene glycol, dipropylene glycol, ethanolamine, N-methyl-diethanolamine, and the like and mixtures of any of the above. As noted previously, minor proportions, that is less than about 20 equivalent percent, of the difunctional extender may be replaced by trifunctional extenders without detracting from the thermoplasticity of the resulting TPU; illustrative of such extenders are glycerol, trimethylolpropane, and the like.

While any of the diol extenders described and exemplified above can be employed alone, or in admixture, it is preferred to use 1,4-butanediol, 1,6-hexanediol, neopentyl glycol, 1,4-cyclohexanedimethanol, ethylene glycol, and diethylene glycol, either alone or in admixture with each other or with one or more aliphatic diols previously named. Particularly preferred diols are 1,4-butanediol, 1,6-hexanediol, and 1,4-cyclohexanedimethanol. The equivalent proportions of polymeric diol to said extender may vary considerably depending on the desired hardness for the TPU product. Generally speaking, the proportions fall within the respective range of from about 1:1 to about 1:20, preferably from about 1:2 to about 1:10. At the same time, the overall ratio of isocyanate equivalents to equivalents of active hydrogen containing materials is within the range of 0.90:1 to 1.10:1, and preferably, 0.95:1 to 1.05:1.

The TPU's may be prepared by conventional methods which are known to the artisan, for instance, from U.S. Pat. No. 4,883,837 and the further references cited therein.

Other additives known in the art for their art recognized function may also be included in the inventive composition in functional amounts. These include fillers, reinforcing agents, flame retarding agents, mold release agents, lubricants and stabilizers, including thermal, hydrolytic and UV stabilizers as well as dyes and pigments.

Fillers and/or reinforcing agents may be present in the inventive composition in amounts of 5 to 50, preferably 20 to 40 percent relative to the weight of the molding composition. Among these mention may be made of milled glass fibers, that is glass fibers having an average length of about 1/64″ to 1/16″ and or wollastonite.

The preparation of the inventive composition is conventional and may be carried out by following procedures and using equipment that are well known to the art-skilled.

The invention will be better understood with reference to the following examples, which are presented for purposes of illustration rather than for limitation, and which set forth the best mode contemplated for carrying out the invention.

### EXAMPLES

Compositions in accordance with the invention and comparative examples were prepared and their properties determined; a summary of the properties is presented in the table below. In addition to the components indicated below, each of the compositions further contained identical amounts of additives as release agent 0.5 pphr (parts per hundred weight of resin); a nucleating agent, 0.1 pphr; an antioxidant 1.0 pphr; a UV light absorber 1.0 pphr; chopped glass fibers 20.0 pphr and an effective amount of pigments. None of these added components is believed to have criticality in the present context.

The resinous components of the several compositions:

ASA—a blend of butyl acrylate rubber having a bimodal particle size distribution of 0.4 microns and 0.15 microns. Both modes comprise styrene-acrylonitrile copolymer grafted onto a core-shell structured rubber substrate. The core contains styrene and the shell is crosslinked poly(butyl acrylate). The weight ratio between rubber and the grafted SAN was about 100:80; the weight ratio between the styrene and acrylonitrile was about 70/30.

PET—polyethylene terephthalate, CAS# 25038-59-9, Versatray 12822 supplied by Eastman Chemical (intrinsic viscosity of 0.92 to 0.98 [solvent: phenol/tetrachloro ethane 60/40])

PBT—polybutylene terephthalate; Pocan B1500 (intrinsic viscosity of 1.21 to 1.28 [solvent: phenol/tetrachloro ethane 60/40]);a product of Bayer Polymers

TPU—polyester-polyol based thermoplastic polyurethane Texin 285; Shore A hardness of 85, a product of Bayer Polymers.

The compounding of the compositions and the molding of test specimens were carried out following the procedures summarized below:

| | |
|---|---|
| Compounding | ZSK 30-mm twin-screw extruder |
| Extruder: | |
| Melt Temperature: | Set at: 200, 240, 270, 280, 285, 250 degree C. for |
| | Zone-1, 2, 3, 4, 5 and die, respectively |
| Screw Speed: | 300 rpm |

The equipment and parameters used in the injection molding were as follows:

| | |
|---|---|
| Molding Machine: | New Britain 200-Ton |
| Melt Temperature: | Set at: 500, 500, 500, 500 degree F. for |
| | Zone-1, 2, 3 and nozzle, respectively |
| Mold Temperature: | Set at: 180 degree F. |

The resinous content of the compositions and their properties are summarized in the tables below.

The examples designated C-1, C-2 and C-3 are comparative examples. As shown in Table 1, except for Examples C-3 and Exp-7 and Exp-8, where the thermoplastic polyester component was entirely of PBT, this component in remaining example contained equal weights of PBT and PET.

TABLE 1

| | C-1 | Exp-1 | Exp-2 | Exp-3 | Exp-4 | C-2 | Exp-5 | Exp-6 | C-3 | Exp-7 | Exp-8 |
|---|---|---|---|---|---|---|---|---|---|---|---|
| ASA | 20 | 20 | 20 | 10 | 15 | 30 | 30 | 20 | 20 | 20 | 10 |
| PET | 40 | 40 | 40 | 40 | 40 | 35 | 35 | 35 | 0 | 0 | 0 |
| PBT | 40 | 40 | 40 | 40 | 40 | 35 | 35 | 35 | 80 | 80 | 80 |
| TPU | 0 | 10 | 5 | 10 | 5 | 0 | 10 | 10 | 0 | 10 | 10 |
| Resin | 100 | 110 | 105 | 100 | 100 | 100 | 110 | 100 | 100 | 110 | 100 |
| Total | | | | | | | | | | | |

Table 2 shows the compositional makeup of the examples in terms of percentage related to the total weight of resin

TABLE 2

| | C-1 | Exp-1 | Exp-2 | Exp-3 | Exp-4 | C-2 | Exp-5 | Exp-6 | C-3 | Exp-7 | Exp-8 |
|---|---|---|---|---|---|---|---|---|---|---|---|
| ASA | 20 | 18.2 | 19.0 | 10 | 15 | 30 | 27.3 | 20 | 20 | 18.2 | 10 |
| PET | 40 | 36.4 | 38.1 | 40 | 40 | 35 | 31.8 | 35 | 0 | 0 | 0 |
| PBT | 40 | 36.4 | 38.1 | 40 | 40 | 35 | 31.8 | 35 | 80 | 72.7 | 80 |
| TPU | 0 | 9.1 | 4.8 | 10 | 5 | 0 | 9.1 | 10 | 0 | 9.1 | 10 |

The properties shown in Table 3 were determined as outlined below:

Vicat refers to ASTM D1525, with the indicated applied load. The temperature of the oil increased at a rate of 2 degree ° C./min.

DTUL refers to ASTM D648, with the indicated applied load. The temperature of the oil increased at a rate of 2 degree ° C./minute

Izod refers to ASTM D256, at the indicated temperature (RT refers to room temperature). The samples measured 6.35 cm×1.27 cm×indicated thickness. The test specimens were milled with a 0.25 cm. radius notch at midpoint to a remaining height of 10.2 mm.

The tensile properties, Mpa, were run at room temperature using an Instron Univeral Machine with cross-head speed of 5 mm/minute in accordance with ASTM D-638. Type I tensile bars.

Viscosity (2000 1/s, 260° C.), Pa-s; Kayeness capillary rheometer was used to evaluate the viscosity at 1000 and 2000 1/s, in accordance with ASTM D383.

TABLE 3

| | C-1 | Exp-1 | Exp-2 | Exp-3 | Exp-4 |
|---|---|---|---|---|---|
| ASA | 20 | 20 | 20 | 10 | 15 |
| PET | 40 | 40 | 40 | 40 | 40 |
| PBT | 40 | 40 | 40 | 40 | 40 |
| TPU | 0 | 10 | 5 | 10 | 5 |
| DTUL, ° C. | 95 | 84 | 119 | 89 | 88 |
| Vicat (1 Kg), ° C. | 218 | 211 | — | 210 | 215 |
| Tensile Strength, Mpa | 84 | 88 | 65 | 93 | 95 |
| Tesnile Modulus, Gpa | 6.5 | 5.8 | 6.4 | 6.3 | 6.9 |
| Elongation @ Fail, % | 2.4 | 3.6 | 1.4 | 3.9 | 3.7 |
| Viscosity (1000 1/s) Pa-s | 327 | 177 | 228 | 159 | 234 |
| Viscosity (2000 1/s), Pa-s | 219 | 130 | 161 | 120 | 166 |
| Izod (⅛″), ft-lb/′in | 1.3 | 2.0 | 1.5 | 1.9 | 2.0 |
| Izod (¼″), ft-lb/′in | 1.2 | 1.9 | 1.3 | 1.6 | 2.0 |

The addition of the TPU into the blends comprising ASA (20 parts), PET (40 parts), and PBT (40 parts), the Izod impact strength was increased, along with the increase of flowability shown as lowered viscosity. The higher amount of TPU added the lower viscosity was achieved.

TABLE 4

| | C-2 | Exp-5 | Exp-6 |
|---|---|---|---|
| ASA | 30 | 30 | 20 |
| PET | 35 | 35 | 35 |
| PBT | 35 | 35 | 35 |
| TPU | 0 | 10 | 10 |
| DTUL, C | 93 | 78 | 80 |
| Vicat. C | 213 | 200 | 207 |
| Tensile Strength, Mpa | 73 | 78 | 83 |
| Tesnile Modulus, Gpa | 5.8 | 5.5 | 5.7 |
| Elongation @ Fail, % | 2.7 | 5.5 | 4.6 |
| Viscosity (1000 1/s), Pa-s | 321 | 210 | 182 |
| Viscosity (2000 1/s), Pa-s | 211 | 147 | 132 |
| Izod, ⅛″, ft-lb/′in | 1.5 | 2.4 | 2.1 |
| Izod, ¼″, ft-lb/′in | 1.4 | 2.4 | 2.0 |

The addition of the TPU into the blends comprising ASA, PET, and PBT (35 parts, and 35 parts, respectively for PET and PBT) the Izod impact strength was increased, along with the increase of flowability shown as lowered viscosity.

TABLE 5

| | C-3 | Exp-7 | Exp-8 |
|---|---|---|---|
| ASA | 20 | 20 | 10 |
| PET | 0 | 0 | 0 |
| PBT | 80 | 80 | 80 |
| TPU | 0 | 10 | 10 |
| DTUL, C | 157 | 170 | 185 |
| Vicat. C | 217 | 210 | 214 |
| Tensile Strength, Mpa | 81 | 83 | 89 |
| Tesnile Modulus, Gpa | 6.3 | 5.9 | 5.9 |
| Elongation @ Fail, % | 1.8 | 4.1 | 4.6 |
| Viscosity (1000 1/s), Pa-s | 319 | 174 | 157 |
| Viscosity (2000 1/s ), Pa-s | 215 | 128 | 119 |
| Izod, ⅛″, ft-lb/′in | 1.1 | 1.8 | 1.9 |
| Izod, ¼″, ft-lb/′in | 1.1 | 1.8 | 1.9 |

The addition of the TPU into the blends comprising ASA (20 parts), PET (40 parts), and PBT (40 parts), the Izod impact strength was increased, along with the increase of flowability shown as lowered viscosity. The higher amount of TPU added the lower viscosity was achieved.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A thermoplastic molding composition comprising a resinous blend of
(i) 2 to 60% of a grafted acrylate rubber
(ii) 10 to 97% of thermoplastic polyester, and
(iii) 1 to 30% of thermoplastic polyurethane, the percents being relative to the weight of the blend.

2. The thermoplastic molding composition of claim 1 wherein thermoplastic polyester is polybutylene terephthalate.

3. The thermoplastic molding composition of claim 1 wherein thermoplastic polyester contains PBT and PET.

4. The thermoplastic molding composition of claim 1 wherein (i) is present in an amount of 5 to 45%.

5. The thermoplastic molding composition of claim 1 wherein (ii) is present in an amount of 20 to 93%.

6. The thermoplastic molding composition of claim 1 wherein (iii) is present in an amount of 2 to 20%.

7. A thermoplastic molding composition comprising a resinous blend of
(i) 5 to 45% grafted acrylate rubber,
(ii) 20 to 93% thermoplastic polyester and
(iii) 2 to 20% thermoplastic polyurethane, the percents being relative to the weight of the blend.

8. The thermoplastic molding composition of claim 7 wherein thermoplastic polyester is polybutylene terephthalate.

9. The thermoplastic molding composition of claim 7 wherein thermoplastic polyester contains PBT and PET.

10. The thermoplastic molding composition of claim 3 wherein the amount of PET is 0 to 90 percent relative to the weight of the thermoplastic polyester.
